(19) United States
(12) Patent Application Publication
(10) Pub. No.: US 2002/0049812 A1
(43) Pub. Date: Apr. 25, 2002

(54) System and method for directing shared data

(76) Inventor: Yuval Nahon, Tel-Aviv (IL)

Correspondence Address: ROSENMAN & COLIN LLP, 575 MADISON AVENUE, NEW YORK, NY, 10022-2585, US

(21) Appl. No.: 09/797,420

(22) Filed: Mar. 1, 2001

Related U.S. Application Data
(63) Continuation-in-part of application No. 09/654,647, filed on Sep. 5, 2000.

(51) Int. Cl. G06F 15/16

(52) U.S. Cl. 709/204; 709/218

(57) ABSTRACT

There are disclosed systems and methods coordinating browsing or cobrowsing that employ an intermediate or proxy server between the clients (customer and agent) and the network, such as the Internet. This intermediate server is configured such that during cobrowsing between at least two clients, the network, such as the Internet, is accessed a single time through a single channel or “pipe” for all clients of this cobrowsing event. Also employed is a filter that receives a data stream with the retrieved target data object accessed from the Internet, and analyzes it for a rule key. If a rule key is not detected, the data stream is passed through the filter to a storage unit of the proxy server for its being provided to all cobrowsing clients. However, should a rule key be detected, the target data object is modified in accordance with a rule corresponding to the rule key. This modified target data object is then passed to the storage unit of the intermediate or proxy server for its being provided to all cobrowsing clients.

### CROSS-REFERENCES TO RELATED PATENT APPLICATIONS

This patent application is a continuation-in-part patent application of U.S. patent application Ser. No. 09/654,647, filed Sep. 5, 2000, commonly owned, and entitled: SYSTEM AND METHOD FOR DIRECTING SHARED DATA, that is incorporated by reference in its entirety herein.

### FIELD OF THE INVENTION

The present invention is related applications over Internet Protocol (IP) networks. Particularly, it is directed to methods and systems where client network browsers are synchronized, such that two clients can view the same web page or data object at the same time or “cobrowse”, in a coordinated data collaboration session over a network, such as the Internet. More, particularly, the present invention is directed to methods and systems for supporting cosurfing applications where clients link to a server, that serves as an intermediary to the Internet, such that this server provides all clients accesses to the Internet through a single channel or “pipe”.

### BACKGROUND OF THE INVENTION

The Internet has emerged as an effective way to speed transactions and provide service to an ever growing number of users, that by early 2000 is expected to exceed 47 million. Along with this growth in users, has come the growth of electronic commerce or “e-commerce”, online transactions typically involving the sale of goods and services. Thousands of businesses have entered into e-commerce, realizing that lucrative profits can be gained by reaching this Internet user population with web-based services, advertising, product promotion and sales.

Typical e-commerce applications are based on cobrowsing, where two users or clients browsers are coordinated, and typically synchronized, such that they can both view the same data object, typically a web page within a web document (collectively a “web page”) at the same time. This is typically achieved by both users or clients, commonly known as surfers, who are each connected to the Internet as well as a Data Collaboration (DC) Server. The DC Server receives the Uniform Resource Locator (URL) of a user for the web page or data object being viewed by the client customer. This URL is then transferred from the DC Server to the browser of a second user, typically the client agent, who then obtains the data object, e.g., web page, corresponding to the URL from the Internet or other suitable network.

This conventional form of cobrowsing has several drawbacks when applied to e-commerce. Initially, since both the customer and agent must access the Internet, through their own separate channels or “pipes”, an order could be made twice, once on the customer side and once on the agent side. This is especially true with dynamic web pages, that are separately generated for each Hypertext Transfer Protocol (HTTP) request. Accordingly, two requests are generated to the Internet, one from the customer and one from the agent, resulting from two postings of the HTTP request to the web server. This results in duplicate orders being made, when only one was intended.

Additionally, an organization wishing to provide e-commerce services with cobrowsing must purchase a complete cobrowsing application, and install it on their server. This is due to the fact that cobrowsing requires a signaling mechanism from the browser of a client to the DC server, to enable a web page being viewed by a client to be simultaneously viewed by an agent. This signaling mechanism is typically in a footer to the web page, that signals the DC server by passing through a signaling application in the browser, commonly referred to as a “traffic cop”. This footer is typically code within Hypertext Markup Language (HTML), such as an HTML formatted file that an organization added to its web page on its server. The traffic cop is, for example, a Java applet that holds a signaling interface to the DC server and monitors footers for events.

The customer will download the requisite software, code, etc., from this organization's, company's or the like (hereafter “organization) server, in order to perform transactions requiring cobrowsing. These software packages can be expensive, to a price point where an organization may find it unprofitable to facilitate e-commerce in this manner or this may be an entry barrier for e-commerce. Additionally, a footer installed on a web page interferes with regular browsing, as it searches for a “traffic cop” application, that is only present in cobrowsing and not present during regular browsing.

Another drawback to these conventional cobrowsing systems is that all of the frames, typically four, the web page itself, the footer, the cobrowsing function (for example, Surf & Call™ from VocalTec, Ltd. Herzlia, Israel) and a “traffic cop”, that form the cobrowsing application for cobrowsing the data object, must be from the same domain. This allows the URL of the web page to be passed to the DC server for cobrowsing that web page.

Specifically, the footer must be recognizable to the traffic cop, as being an event of the same domain, if the URL of the web page is to be passed to the DC Server. Otherwise, the URL for the web page would be stopped by the traffic cop and not passed to the DC Server. Thus, should a linked web page of one domain be in the same series of frames with a traffic cop of a different domain, this web page can not be cobrowsed as the traffic cop will not pass its URL to the DC server. Rather, the sender will receive an error message that this operation is not possible. Likewise, if a web page from a different domain to that of the customer's (or client's) suddenly appears in the frames that have been customized to have the same number of domains, an error message will also appear. This often occurs when a web site or customer, has a link to a different web site, and the web page is taken from a different domain when the link is selected.

### SUMMARY OF THE INVENTION

The present invention improves on the contemporary art by providing systems and methods for coordinating browsing or cobrowsing that employ an intermediate or proxy server between the clients (customer and agent) and the network, such as the Internet. This intermediate server is configured such that during a cobrowsing event between at least two clients, the network, such as the Internet, is accessed a single time through a single channel or “pipe” for all clients of this cobrowsing event. Accordingly, once one cobrowsing client requests a particular target data object, typically a web page, only one HTTP request is generated, for example by a HTTP “post” command. From this single request and subsequent single retrieval of the web page through the single channel or “pipe”, all clients will receive this target web page.

In an e-commerce application, only one order would be generated, as the network, such as the Internet, would only have been accessed once, through a single channel or “pipe” for all cobrowsing clients. Additionally, this single channel or “pipe” network access results in faster transmissions of data objects, typically web pages to the clients, when compared to all clients accessing the same web page, each through their own separate channels. Additionally, in an e-commerce application, only one order would be generated, as a result of this single time, single channel access to the desired web page. Moreover, the intermediate or proxy server of the present invention eliminates the need for each organization to have its own cobrowsing application in or associated with its server, as instead, the organization need only have a link on their web page to the intermediate or proxy server. This is because the intermediate server is configured to pass a cobrowsing functionality to the recipient client in addition to providing a single channel or “pipe” to the Internet for all clients of a cobrowsing session.

One embodiment of the present invention is directed to a system for facilitating coordinated browsing of a data object or objects, typically a web page or web pages, from a web application server, between at least two clients. This embodiment comprises, a first utility for opening a channel to at least one web application server on a network, typically the Internet, and retrieving at least one target data object from this at least one web application server through the opened channel in accordance with a request for this data object from a first client. There is a second utility for providing the at least one target data object retrieved from the at least one application server to a storage medium. There is a third utility for transferring this at least one data object from the storage medium to the first client, who requested this target data object (otherwise known as the requesting client). There is also a fourth utility for transferring the at least one data object from the storage medium to a second client, in response to a corresponding request from the second client for this data object. This system can also include a fifth utility for changing the domain of the retrieved at least one target data object data to the domain corresponding to the first utility, and placing a command onto the retrieved target data object to access the first utility, when a second target data object is requested by any of the clients. Additionally, the system can be such that the first utility is responsive to a link on a web page, when this link is activated by at least one of the clients.

Another embodiment of the present invention is directed to a system for facilitating coordinated browsing of data objects, typically web pages, from a web application server, between at least two clients. This system comprises a server for positioning intermediate the at least two clients and a network, typically the Internet. The server comprises a storage medium and a processor. The processor is programmed to: open a channel to at least one web application server on the network, and retrieve at least one target data object from this at least one web application server through the opened channel in accordance with a request for this data object from a first client; provide at least one target data object retrieved from the at least one application server to a storage medium; transfer this at least one data object from the storage medium to the first client; and transfer the at least one data object from the storage medium to a second client, in response to a corresponding request for the data object from the second client. The processor is additionally programmed to change the domain of the retrieved at least one target data object to the domain corresponding to that of the server; and place a command onto the retrieved target data object to access the server, when a second target data object is requested by any of the clients. The system may also include a web page having a link to the server, and also included may be a data collaboration server configured for holding and synchronizing cobrowsing events between the clients.

Another embodiment of the invention is directed to a method for coordinated browsing of data objects, typically web pages, from a web application server, between at least two clients. This method comprises, opening a channel to at least one web application server on a network, typically the Internet, and retrieving at least one target data object, typically a web page, from the at least one web application server through the opened channel in accordance with a request for this data object from a first client. This at least one target data object retrieved from the at least one application server is provided to a storage medium. The at least one data object is transferred from the storage medium to the first client, and this at least one data object is also transferred from said storage medium to a second client, in response to a corresponding request for this data object from the second client. The method may also include changing the domain of the retrieved at least one target data object to the domain corresponding to that of a network accessing component, such as a server, intermediate the clients and the network, for accessing the at least one web application server; and placing a command onto the retrieved target data object to access the intermediate server, when a second target data object is requested by any of the clients. The method may also include accessing this intermediate server by a client activating a link on a web page, this link for directing the client browser to this intermediate server.

Another embodiment of the invention is directed to a method for facilitating coordinated browsing of data objects, typically web pages, from a web application server on a network, typically the Internet, between at least two clients. The method comprises positioning a server intermediate the at least two clients and the network, opening a channel to the at least one web application server on the network, and retrieving at least one target data object (e.g., a web page) from the at least one web application server through the opened channel in accordance with a request for the data object from a first client. The at least one target data object retrieved from the at least one application server is then provided to a storage medium. The stored data object is then transferred from the storage medium to the first client and from the storage medium to the second client, this transfer to the second client in response to a corresponding request for the data object from this second client. This method may additionally comprise providing a web page having a link to the server, with a client activating this link, as well as providing a data collaboration server for holding and synchronizing cobrowsing, typically in each cobrowsing event, between the clients.

Another embodiment of the present invention is directed to a method for facilitating coordinated browsing of data objects, typically web pages, from a web application server on a network, typically the Internet, between at least two clients, from the client side. This method comprises a first client transmitting a first request for a target data object to a server intermediate the at least two clients and the network, for this intermediate server to retrieve the at least one target data object from a web application server on the network and this first client transmitting a second request to a second client to access this intermediate server, for retrieving the at least one target data object in accordance with the first request.

### BRIEF DESCRIPTION OF THE DRAWINGS

Attention is now directed to the attached drawings, wherein like reference numerals or characters indicate corresponding or like components. In the drawings:

FIG. 1 is a diagram of an exemplary set up employing an embodiment of the present invention;

FIGS. 2a and 2b are a flow diagram of a process in accordance with an embodiment of the present invention for the initial cobrowsing event;

FIG. 3a is a schematic diagram of frames as assembled into a web document in accordance with an embodiment of the present invention;

FIG. 3b is a screen shot of a web document in accordance with an embodiment of the present invention;

FIG. 4 is a diagram of the exemplary set-up of FIG. 1 in a subsequent cobrowsing event;

FIG. 5 is a flow diagram of a process in accordance with an embodiment of the present invention for subsequent cobrowsing events;

FIG. 6 is a diagram of the an alternate embodiment of the intermediate or proxy server in a system in accordance with the present invention; and;

FIG. 7 is diagram detailing the operation of the rule filter of FIG. 6.

### DETAILED DESCRIPTION OF THE DRAWINGS

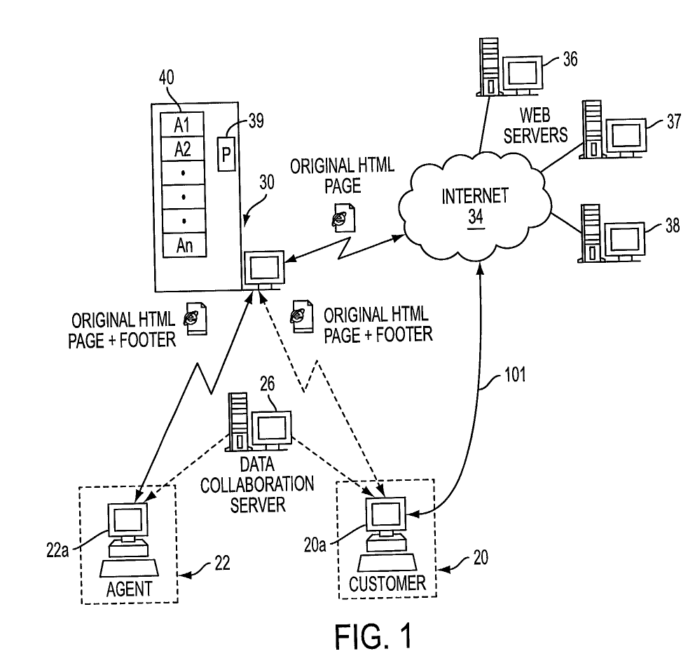

FIG. 1 shows an exemplary set up employing an embodiment of the present invention. Here, for example purposes, are shown two clients 20, 22, a customer client or customer 20 who seeks to cobrowse with an agent client or agent 22. Both the customer 20 and agent 22 clients are configured for connecting to a Data Collaboration (DC) Server 26 and an Intermediate or proxy server 30, respectively. This Intermediate or proxy server 30, typically communicates with a network, such as a local area network (LAN) or a wide area network (WAN), typically the Internet 34. Various web servers 36, 37, 38 are connected to the Internet 34. These servers 36-38 are exemplary of the endless number of servers that are connected to the Internet 34.

From the customer side, the customer 20 has a multimedia workstation, such as a multimedia PC 20a (e.g., with a Pentium® CPU from Intel Corporation, Santa Clara, Calif. 95052) with voice and data capabilities. In this way, a cobrowsing application with voice and data capabilities may be used, such as any of the Surf & Call™ cobrowsing applications available from VocalTec, Herzlia, Israel. The multimedia PC 20a employs an operating system such as Windows® NT® (from Microsoft Corporation, Redmond, Wash. 98052) or the like, and is equipped with a suitable modem or other hardware for accessing the DC Server 26, intermediate server 30, and network, such as the wide area network (WAN), here the Internet 34. The PC 20a is also loaded with software that operates as a browser for the Internet. Exemplary browsers suitable for use here including Microsoft® Internet Explorer® (Microsoft Corporation, Redmond, WA) and Netscape®) Navigator® and Netscape® Communicator, the later two from Netscape Communications Corporation, Mountain View, Calif. 94043.

On the agent side, is typically at least one web enabled agent 22. While one agent is shown and described, this is exemplary only, for any number of agents (one or greater) is permissible in accordance with the present invention. The agent 22 is typically equipped with a multimedia workstation, such as a multimedia PC 22a with voice and data capabilities, and includes browsers, in accordance with those detailed above. The agent 22 can also use regular (POTS) telephone for audio, typically voice.

The DC Server 26 is typically a server with software and or hardware arranged therein for holding and synchronizing cobrowsing sessions between clients, here for example, the customer 20 and the agent 22, described in detail below. It may also be connected to other servers, such as T-servers and the like, that support voice and data communications.

The intermediate or proxy server 30 is connected to the Internet 34 in a way that it accesses Internet and retrieves the requested data object, data stream or the like, that is typically a web page (and will be referred to hereinafter as “web page”), through a single connection (channel or “pipe”). This allows for the same web page, as retrieved through the single channel or “pipe”, to subsequently be sent to both customer 20 and agent 22. This Intermediate Server 30 typically includes a processor (P) 39 programmed such that in conjunction with software, hardware or both, accesses the Internet and retrieves any requested web page in communication with a storage unit 40 or other similar data storage device or storage medium with addressable memory units (A1-An). The server 30 also includes hardware, software or combinations thereof, that in conjunction with the processor (P) 39, programmed accordingly, assembles web documents for both the customer 20 and agent 22. These web documents include at least the web page and a footer, typically both in frames.

One web document is assembled to appear as a customer workstation on the monitor of the client customer 20 (detailed below). This web document can be formed, for example, as the intermediate server 30 takes the retrieved web page and adds a footer to this page, a cobrowsing functionality, a traffic cop or signaling functionality, and optionally, a form sharing page functionality, for example Surf & Chat™ (VocalTec Communications Ltd., Herzlia 46733, Israel). All of these functionalities may be stored in the storage unit 40 of the intermediate server 30, or can be retrieved from various servers on the Internet 34. All of these functionalities are of the same domain, that of the intermediate server 30, such that the retrieved web page can be cobrowsed by both customer 20 and agent 22, as detailed below.

The cobrowsing functionality, may for example, be any of the Surf & Call® applications, for example Surf & Call® Center™ from VocalTec Communications Ltd., Herzlia 46332, Israel. This Surf & Call® Center™ includes an embedded plug-in for facilitating an Internet Protocol (IP) call between clients, here customer 20 and agent 22 along with a Cosurfer Data Collaboration (DC) Component, such as the VocalTec® Cosurfer DC Component™ (VocalTec Communications, Ltd., Herzlia 46332, Israel), for facilitating data calls to the DC server 26.

The footer is typically code that dynamically replaces the real target location (the URL) with the location (the URL) of the intermediate or proxy server 30. It also invokes a surf command, typically HTTP language, code, etc., for the recipient client (via their respective workstation) to go to the Intermediate or proxy server 30 and ultimately retrieve the real target web page from the Internet, or alternately, from the intermediate or proxy server 30, if the web page has been retrieved by a cobrowsing client prior to this.

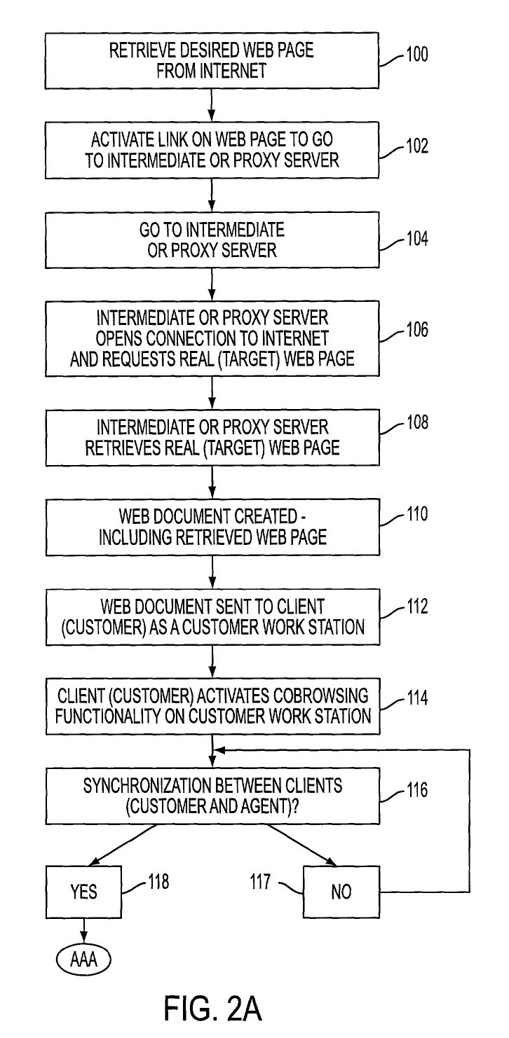

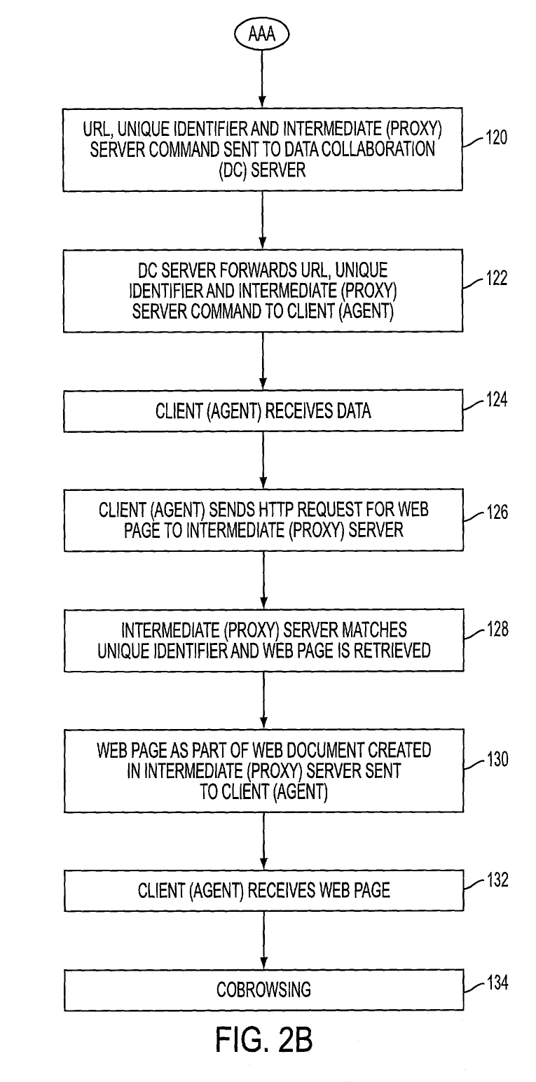

Turning also to FIGS. 2a and 2b, implementation of an initial cobrowsing processor event, in accordance with the present invention, will now be described in an exemplary e-commerce application. Initially, the server operator, here the server of the agent client 38, has placed a link on its web page, to direct the client browser, to the intermediate or proxy server 30, preferably after the requisite client has reached the web page by regular browsing (surfing). The link typically includes a surf command, such as an HTTP command—for the intermediate or proxy server 30 to retrieve the requested (target) web page from the Internet 34. This command also instructs the retrieval of the real (target) web page by the intermediate or proxy server 30 to have an associated identifier, typically a unique identifier (UID), as detailed below. Upon retrieval of the web page, the web page is placed into the storage unit 40 with this unique identifier. Here for example, this web page originates from the server operator's server, labeled 38. Also, for purposes of this example, it will be noted that this server 38 has a URL of http://www.abc.com, such that its domain is “abc”.

At block 100, the client customer 20, via his workstation 20a, browses the Internet 34 to the web site corresponding to abc.com, in accordance with arrow 101, such that the web page of address http:www.abc.com, has been retrieved and now appears before him on his workstation 20a monitor. The web page of address abc.com, will include a link to the intermediate or proxy server. This link can appear on the web page as a hypertext block or the like, activated by clicking (pressing) a mouse or the like. For example, this hypertext block may be a text message such as, “DO YOU WANT HELP IN BROWSING?”

The client, here the customer 20, now activates the link on this web page, at block 102, and the client customer's browser is routed to the Intermediate or proxy server 30, at block 104. The Intermediate server 30 then opens a connection (channel or “pipe”), such as an HTTP connection, to the real (target) site and requests this URL (i.e., requests the web page corresponding to the URL) from the Internet 34, at block 106. The web page corresponding to this URL is then retrieved, at block 108. A unique identifier (UID), typically a series of numbers unique to this web page retrieval, that follows requests for this web page, is in place when the intermediate or proxy server retrieves the desired (target) web page from the Internet 34. This unique identifier can be generated in the browser, intermediate or proxy server 30 or in any other server or the like along the Internet 34. For purposes of this example, the specific UID for this first cobrowsing event is 33333. The command to retrieve a web page from the intermediate or proxy server 30 also contains a command to attach the UID to this particular event.

The now-retrieved web page, corresponding to this URL www.abc.com is stored in the storage unit 40, with the unique identifier in an addressable memory unit(s). Within this intermediate server 30, at block 110, the retrieved web page will now become part of a web document, that will appear as a customer work station on the workstation 20a of the customer client 20.

The web document assembly occurs as the source web page address, here abc.com, is parsed to a source web document address, contacting the intermediate or proxy server address, here proxy.com. The web page, here, abc.com, is parsed and converted to a frame. Parsing involves embedding the web page's original URL, here abc.com, within an address containing the URL of the domain of the Intermediate or proxy server, here proxy.com. This ensures that the domain is now that of the intermediate or proxy server. The unique identifier (UID) associated with the web page in the storage device 40 is attached to the page during the parsing process.

The parsed address, here proxy.com, is placed into an HTTP command, expressed as, http://www.proxy?VESCC_LOCATION=http://www.abc.com&VESCC_UID=33333, for example. This command indicates connecting to the URL, abc.com, through the intermediate or proxy server 30 (the domain of the intermediate or proxy server 30 is “proxy”) and a unique identifier, typically digits, here “33333”. This unique identifier is specific to the original client cobrowsing request for the web page, here the URL abc.com.

The above listed HTTP command is a surf command for a footer. This footer is added as a frame to the web page, as part of the web document being assembled.

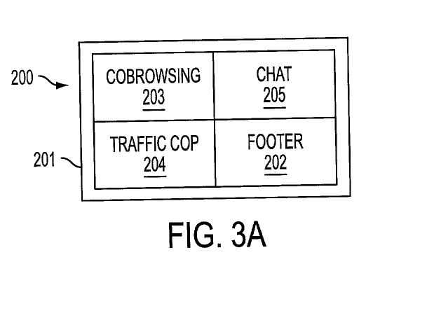

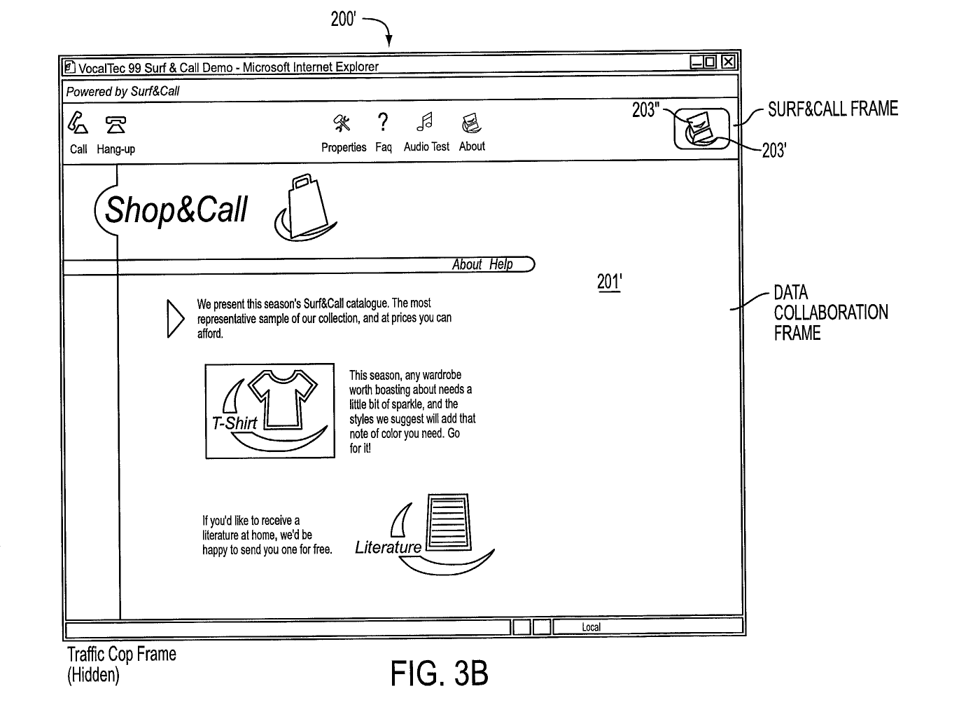

Functionalities (also referred to as applications herein) in frames, such as a cobrowsing application, traffic cop and form sharing application frames are added to, or alternately joined with, the web page and footer frames, resulting in the assembled web document. FIG. 3a schematically shows the assembled web document 200, including frames for the web page 201, footer 202, cobrowsing application 203, traffic cop 204, and optionally, a form sharing application 205. This assembled web document 200 is sent to the client, here the customer 20, at block 112. It appears on the monitor of the client workstation, as a customer workstation 200′, shown in FIG. 3b.

Continuing with FIG. 3b, the customer workstation 200′ includes the web page frame 201′, a footer frame (not shown), a cobrowsing application frame 203′, for example any of the cobrowsing applications from VocalTec Communications, Herzlia, Israel, for example, the data collaboration (DC) component, that is part of the VocalTec® Surf & Call® Center™, a traffic cop frame (not shown), and optionally, a form sharing page frame (not shown). All of the frames in the assembled web document 200 and resultant customer work station 200′, are of the same domain, here “proxy”, the domain of the intermediate or proxy server 30. With respect to the cobrowsing application frame, it can for example, work simultaneously with the Surf & Call® embedded plug-in, as represented by the Surf & Call® icon 203″, should a Surf & Call™ application be employed. Thus, the user, here the requisite client, invokes the DC component together with the Surf & Call® plug-in by pressing a single button (clicking on the Surf & Call® icon 203″).

The customer 20 can now activate the cobrowsing application at block 114, either manually, by clicking on the cobrowsing application frame 203′, here, the Surf & Call icon 203″, as detailed above, or the cobrowsing application will activate automatically (if the client customer 20 workstation is programmed accordingly, or if the requisite software has been downloaded). The client customer 20 now waits for synchronization of his browser with the browser of the agent, at block 116, to enable the DC server 26 to connect the intended cobrowsing clients. If there is not synchronization between clients (customer and agent), at block 117, the wait continues until there is synchronization. Synchronization may be manual or automatic.

If there is synchronization, at block 118, the URL of the web page to be cobrowsed and information in the footer (in the footer frame) (e.g., the command to go to the requested web page via the intermediate or proxy server 30 and the unique identifier) is sent to the DC server 26, from the client (here, the customer client 20), at block 120. Specifically, since all frames are of the same domain, here, proxy.com, for the intermediate or proxy server 30, the footer catches the event and the traffic cop functionality allows passage of the footer information to be sent to the DC server 26.

The DC server 26 then forwards this footer information to the agent workstation 22a, at block 122. Once this information is received by the agent workstation 22a, at block 124, the agent workstation 22a then sends a request (as per the HTTP command) to the intermediate server 30 for the original web page, http://www.abc.com, at block 126. Once the intermediate server 30 receives this request, the unique identifiers are matched at block 128. Upon matching, the stored web page is retrieved from the requisite memory unit of the storage unit 40. A web document of at least a web page and footer are then sent to the agent workstation at block 130 and received there at block 132. The cobrowsing event is now in progress, at block 134, with the customer 20 and agent 22 in voice and data communication.

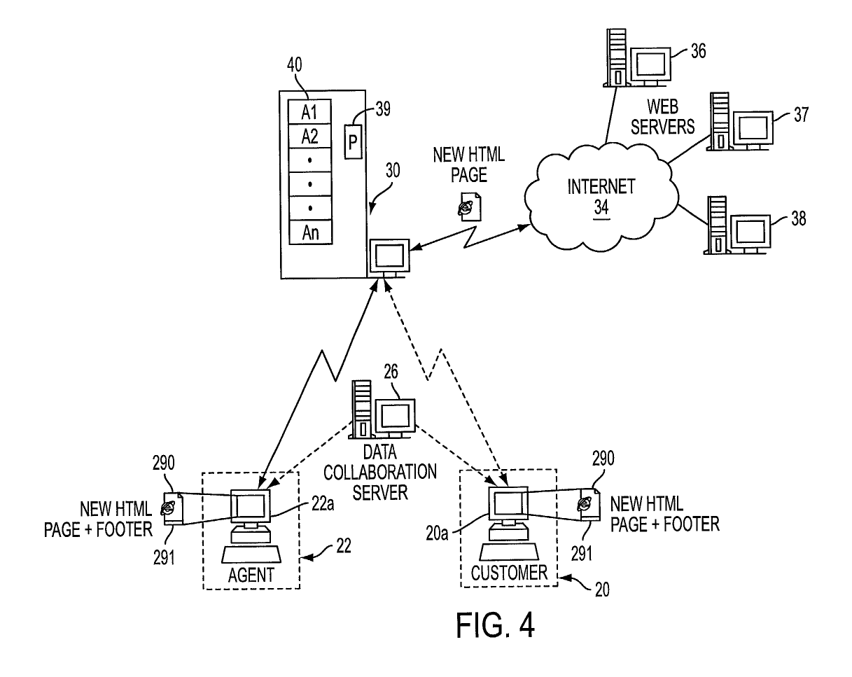

FIG. 4 details a diagram of the client 20 and agent 22 in an exemplary subsequent cobrowsing event. This drawing figure is similar to FIG. 1 (detailed above), and will have the same components except where indicated. Here, at the start of this subsequent cobrowsing event, both the client 20 and agent 22 have received the same web page and their browsers are coordinated and synchronized, in accordance with the initial cobrowsing event detailed above. Specifically, both client and agent workstations have received web documents with web pages 290 with footers 291 (in frames) from the intermediate or proxy server 30 from the preceding cobrowsing event.

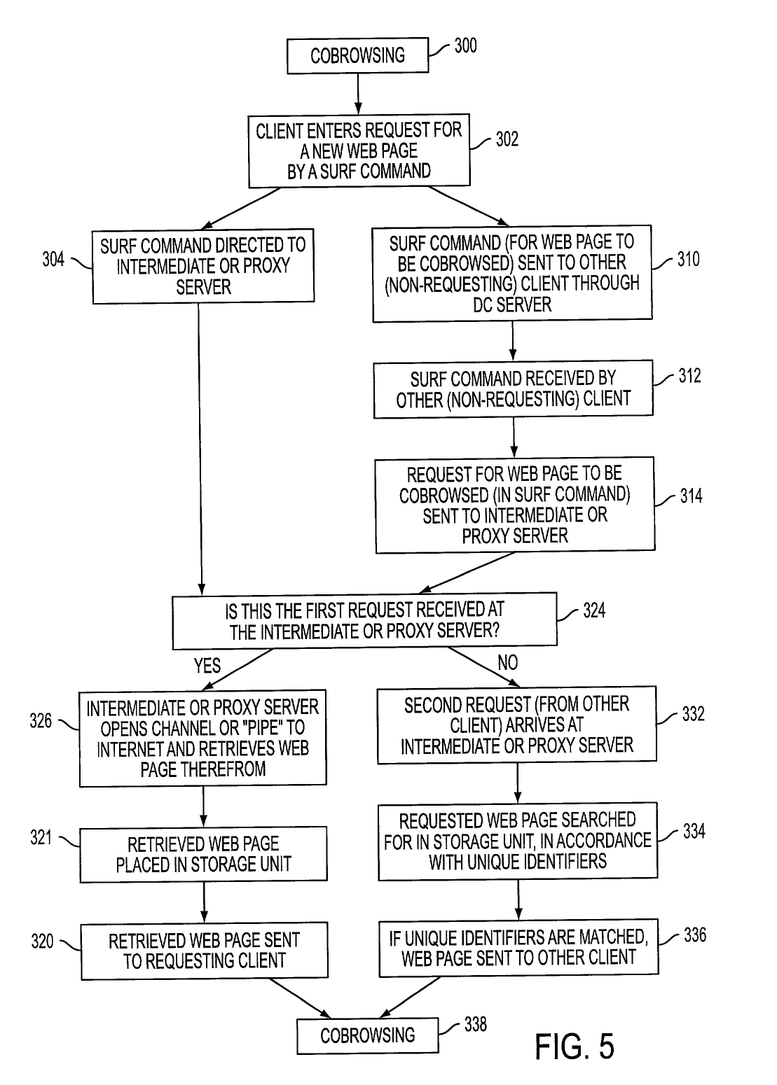

Turning also to FIG. 5, this subsequent cobrowsing event is also shown in a flow diagram. For example, block 300 could be the cobrowsing detailed above (block 134 of FIG. 2b), from where this subsequent cobrowsing session begins. Alternately, this subsequent cobrowsing event can begin from any other cobrowsing event, where clients are cobrowsing.

Continuing with the exemplary operation detailed above, to start this subsequent cobrowsing event, a cobrowsing client, customer or agent requests a different web page, than that of the first request, at block 302. Here for, example, the customer (although it could also be the agent), makes a surf command to its browser by requesting a different or new web page, www.xyz.com, such as by clicking (a mouse or the like) on a new link.

As a result of the footer (footer frame) on the web document, the mouse click is caught and this surf command is directed to the Intermediate or proxy server 30, at block 304. This request is assigned its own unique identifier (UID), here, for example 34343 (for this subsequent or new cobrowsing event), different from the unique identifier (33333) for the preceding cobrowsing session detailed above. The command replaces the original link with http://www.xyz.com, and is expressed by: http://www.proxy?VESCC_LOCATION=http://www.xyz.com&VESCC_UID=34343, similar to the command detailed above.

Contemporaneous in time with the event of block 302, and typically simultaneous therewith, the surf command is sent to the other client, here the agent workstation 22a, through the DC server 26, with the same unique identifier, here 34343, at block 310. Upon receipt of the command, at block 312, the agent workstation, by virtue of the footer serving as the cobrowsing facilitator (facilitating functionality), sends the URL of the new web page and the unique identifier to the intermediate or proxy server 30, at block 314. The footer of the agent web document has been changed to include the received surf command (this surf command as detailed above).

The intermediate or proxy server 30 takes this first received request, at block 324, from the client, here, customer or agent, to the network, e.g., the Internet, by opening a channel or “pipe” thereto (as detailed above), and retrieving the new web page (as detailed above) at block 326. Once in the intermediate server 30, the new web page is placed into the storage unit 40 with addressing therein in accordance with the new unique identifier at block 328. The web page is sent to the workstation of the client whose request was received first, at block 330. Here, the customer would typically receive the web page first (typically as part of a web document detailed above), as his request typically reaches the intermediate or proxy server 30 first, since he initiated the subsequent cobrowsing to www.xyz.com. (Alternately, should the agent's request be received first at the intermediate or proxy server 30, the step above, as well as the steps below would be reversed for customer and agent).

When the second request, from the other client, arrives at the intermediate or proxy server 30, at block 332, the unique identifier in the request is used to find the stored web page of the same unique identifier, at block 334. Once unique identifiers are matched, the web page is sent from the storage unit 40 to the second requesting client's workstation, at block 336. This second request here, is typically from the agent 22, as the customer 20 request reached the intermediate or proxy server 30 first in this example, as detailed above. Cobrowsing continues with the new web page being cobrowsed by the clients, at block 338, and can continue in this manner for as long as desired.

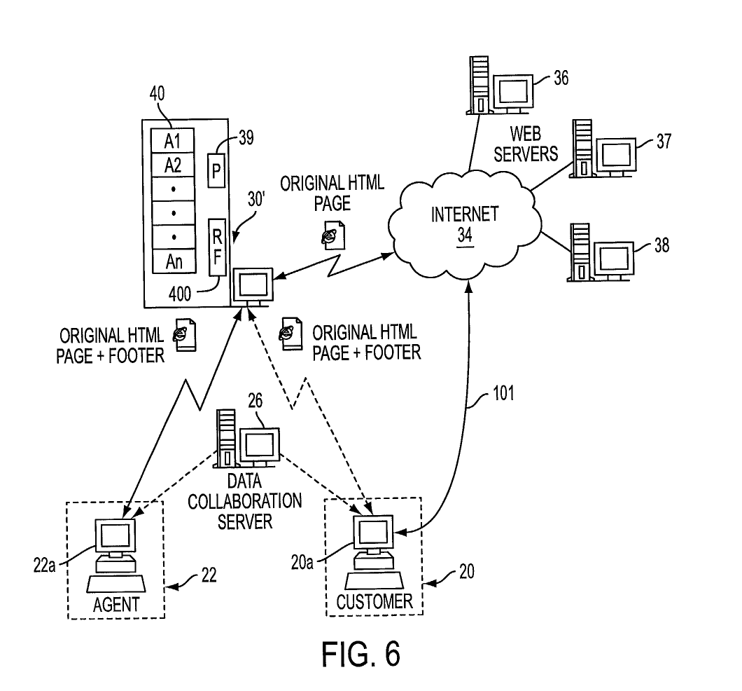

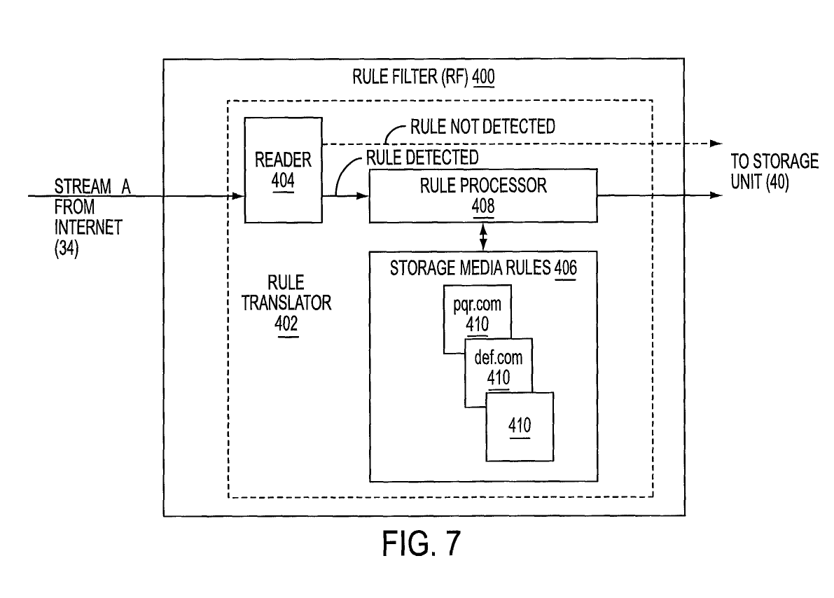

Turning now to FIGS. 6 and 7, there is detailed another embodiment of the present invention. This embodiment is directed to web pages, retrieved from various servers into the intermediate or proxy server 30 (detailed above), that are incompatible with the code lines or code portions or segments (collectively referred to herein as “code”) for web pages in the intermediate or proxy server 30. For example, the retrieved web page or target data object, may be incompatible with the frame arrangement of the intermediate or proxy server 30, or its embedded links are incompatible with the requirement of catching an event (mouse click or keyboard) by the footer in order to access (surf to) the intermediate or proxy server 30, both occurrences described above. To account for this incompatibility, the intermediate or proxy server 30, as detailed above, has been modified with a rule filter (RF) 400. This modified intermediate or proxy server 30′ is similar in all aspects to the intermediate or proxy server 30 detailed above, except with respect to the rule filter 400, and it functions, for example, in conjunction with a system, including components, that has been detailed above and shown in FIGS. 1-5.

The rule filter 400 is shown as internal to the intermediate or proxy server 30′ of FIG. 6, but could also be an external or peripheral component thereto. This rule filter 400 can be software, hardware or combinations thereof. It is used, for example, to change the code on the retrieved web page so that they function correctly in the environment of the intermediate or proxy server 30′, or so that footers perform their intended functions.

The rule filter 400 includes a rule based translator 402, that includes a reader 404, storage media 406 and a rule processor 408. The reader 404 is typically a programmable device, such as a chip or card, programmed for recognizing and reading a rule key from the incoming data stream (indicated as Stream A). This stream typically includes the retrieved web page and the rule key is typically the URL of the web page indicating that a rule is associated with the particular web page.

The storage media 406 is any conventional data storage unit and typically includes files 410, where single or plural rules are stored. These rules are typically related to web pages, for example www.def.com and www.pqr.com, and are stored in files 410 accordingly. These individual rules are for example, instructions to replace incompatible code on the retrieved web page with alternative specified code. This alternate code is created based on the deficiencies of the original web page of the provider (provider web page), this provider utilizing the services and or functions associated with this intermediate or proxy server 30′. (The original or provider web page becomes the retrieved web page or target data object once accessed by the intermediate or proxy server 30′, as detailed above).

In creating the desired rule, code lines or code portions or segments from the original or provider web page(s) are obtained, and a corresponding rule or rules is created (and provided to the rule filter 400, typically programmed therein) to accommodate the incompatibility caused by a code lines or code portions or segments associated with the retrieved web page. Upon invoking a rule (detailed below), the retrieved web page is modified, for example, by augmenting, adding, changing, removing, deleting or replacing or any combination thereof, one or more code lines, code portions or segments, to compensate for the incompatible code lines code portions or segments, resulting in a compatible web page. This now compatible web page is suitable for web document assembly in the intermediate or proxy server 30′ in accordance with the process detailed for the intermediate or proxy server 30, as shown in FIGS. 1-5 and described above. These rules, are typically, for example, from three fields: a) a command, such as, add, replace or remove; b) a source-a regular expression or string on the web page to be, for example, replaced, added or removed; and 3) a destination—typically a code to be added to replace the source.

The rule processor 408 is typically a suitable hardware device, software application or combination thereof, configured and/or programmed to change the retrieved web page in accordance with the rule. Alternatively, for example, the rule modifies and/or changes the retrieved web page so that the required functionality can function in the new environment of the intermediate or proxy server 30′, as detailed above (with respect to the intermediate or proxy server 30).

In operation, when a web page is retrieved, it enters the rule filter 400 in a data stream (Stream A). The reader 404 attempts to find a rule key, for example, the URL of a web page, from the data stream. If a rule key is not found, the web page is passed to the storage unit 40 of the proxy server 30′ (as represented by the broken line arrow of FIG. 7), where it is assembled into a web document as detailed above (for the intermediate or proxy server 30).

If a rule key is found on the retrieved web page (the solid line arrow of FIG. 7 is followed), the corresponding rule or rules file is located in the storage media 406. Once located, the rule processor 408 modifies the retrieved web page in accordance with the requisite rule or rules, so as to be compatible with the pre-configured code (lines, portions and/or segments) of the intermediate or proxy server. The modified web page is then placed into a data stream and sent to the storage unit 40 of the intermediate or proxy server 30′, for placement into the web document as configured in the intermediate or proxy server 30′, as detailed above (for intermediate or proxy server 30).

For example, some web pages contain an instruction to place that web page as the top-most frame in a web browser. This would obscure the multiple frames (including the user toolbar/workstation) that the intermediate or proxy server constructs, as described above. Accordingly, when utilizing a rule key, for example, the URL of the web page, a rule is invoked which replaces the command to position the web page topmost (source) with a command that it occupy a regular frame within the user workstation constructed by the intermediate or proxy server functionality. The rule (In HTML) is, for example, as follows:

Command: Replace

Source: <BASE href=top>

Destination: <BASE href=_self>

Alternatively, for example, if the command is “delete” the destination part of the rule may be left blank.

Another alternate may be, for example, when a functionality in a web page does not require an event (mouse click or keyboard), not affording the footer to catch the event and cause the link or functionality to execute via the intermediate or proxy server 30′. The code responsible for the functionality is then replaced with code containing the functionality together with an added command to access (surf to) the intermediate or proxy server 30′ to mimic the functionality which the footer would have added. This is achieved with a suitable rule. For example, a Meta tag (auto redirect) occurs without an event (mouse click or keyboard event), SO it must be replaced with an automatic redirect command incorporating the accessing (surfing to) the intermediate or proxy server, for example:

Command: Replace
Source: <META HTTP-EQUIV=Refresh CONTENT=“10; URL=http://www.goto.com/”>
Destination: <META HTTP-EQUIV=Refresh CONTENT= “10” URL=
http://www.proxy.com/proxy?VESCC_UID=178345021034560&VESCC_LOCATION=
http://www.goto.com>

It should be noted that there are many other instances in which, for example, the code is modified, by utilizing a rule based translator, in accordance with that described above.

The methods and apparatus disclosed herein have been described with exemplary reference to specific hardware and/or software. The methods have been described as exemplary, whereby specific steps and their order can be omitted and/or changed by persons of ordinary skill in the art to reduce embodiments of the present invention to practice without undue experimentation. The methods and apparatus have been described in a manner sufficient to enable persons of ordinary skill in the art to readily adapt other commercially available hardware and software as may be needed to reduce any of the embodiments of the present invention to practice without undue experimentation and using conventional techniques.

While preferred embodiments of the present invention have been described, so as to enable one of skill in the art to practice the present invention, the preceding description is intended to be exemplary only. It should not be used to limit the scope of the invention, which should be determined by reference to the following claims.

What is claimed is:

1. A method for coordinated browsing of data objects from a web application server, between at least two clients, comprising:
opening a channel to at least one web application server on a network, and retrieving at least one target data object from said at least one web application server through said channel in accordance with a request for said data object from a first client;
analyzing said at least one target data object for at least one rule key;
modifying said at least one target data object if said rule key is detected;
providing said at least one target data object to a storage medium;
transferring said at least one data object from said storage medium to said first client; and
transferring said at least one data object from said storage medium to a second client, in response to a corresponding request for said data object from said second client.

2. The method of claim 1, additionally comprising:
changing the domain of said retrieved at least one target data object to the domain corresponding to that of a network accessing component, said network accessing component for accessing said at least one web application server; and
placing a command onto said retrieved target data object to access said network accessing component, when a second target data object is requested by any of said clients.

3. The method of claim 2, wherein providing said target data object to said storage medium includes providing a unique identifier to said at least one target data object retrieved from said at least one application server.

4. The method of claim 3, wherein said transferring said at least one data object from said storage medium to a second client, includes matching a unique identifier of said second request with said unique identifier of said at least one target data object retrieved from said at least one application server in said storage medium.

5. The method of claim 1, wherein said accessing said at least one application server on a network includes responding to an activated link on a web page, when said link has been activated by at least one of said clients.

6. The method of claim 1, wherein said modifying said at least one target data object if said rule key is detected includes, accessing a predetermined rule corresponding to said rule key.

7. The method of claim 6, wherein said rule includes at least one command for at least one of replacing or removing at least one parameter associated with said target data object retrieved from said at least one application server.

8. The method of claim 6, wherein said rule includes at least one command for adding at least one parameter to said target data object retrieved from said at least one application server.

9. The method of claim 6, wherein said rule includes at providing a source to said target data object retrieved from said at least one application server.

10. The method of claim 9, wherein said providing a source includes providing for at least one of adding, replacing or removing at least one of a regular expression or string with respect to said target data object retrieved from said at least one application server.

11. The method of claim 6, wherein said rule includes at providing a destination to said target data object retrieved from said at least one application server.

12. The method of claim 11, wherein said providing a destination includes providing for at least one of adding, replacing or removing at least one of a regular expression or string with respect to said target data object retrieved from said at least one application server.

13. A programmable storage device readable by a machine, tangibly embodying a program of instructions executable by a machine to perform method steps for providing coordination of the browsers of at least two clients for a target data object, said method steps selectively executed during the time when said program of instructions is executed on said machine, comprising:
opening a channel to a network in response to a first request for a target data object from a first client;
accessing at least one target data object through said channel from at least one web application server on said network in accordance with said first request;
analyzing said requested at least one target data object for the existence of a rule key;
modifying said target data object in accordance with a rule corresponding to said rule key if said rule key exists;
transferring said requested at least one target data object to said first client;
transferring said at least one target data object to said second client in response to a second request for said at least one target data object from a second client, said second request corresponding to said first request as received from said first client.

14. A system for facilitating coordinated browsing of data objects from a web application server, between at least two clients, comprising:
a server for positioning intermediate said at least two clients and a network, said server comprising:
a storage medium; and
a processor, said processor programmed to:
open a channel to at least one web application server on a network, and retrieve at least one target data object from said at least one web application server through said channel in accordance with a request for said data object from a first client;
provide at least one target data object retrieved from said at least one application server to a storage medium;
analyze said at least one retrieved target data object for a rule key;
modify said retrieved target data object in accordance with a predetermined rule corresponding to said rule key, if a rule key exists;
transfer said at least one data object from said storage medium to said first client; and
transfer said at least one data object from said storage medium to a second client, in response to a corresponding request for said data object from said second client.

15. The system of claim 14, wherein said processor is additionally programmed to:
change the domain of said retrieved at least one target data object to the domain corresponding to that of said server; and
place a command onto said retrieved target data object to access said server, when a second target data object is requested by any of said clients.

16. The system of claim 14, wherein processor is additionally programmed to:
provide a unique identifier to said at least one target data object retrieved from said at least one application server.

17. The system of claim 16, wherein said processor is additionally programmed to: match a unique identifier of said second request with said unique identifier of said at least one target data object retrieved from said at least one application server in said storage medium, prior to transferring said at least one retrieved target data object to said second client.

18. The system of claim 14, additionally comprising:
a web page having a link to said server.

19. The system of claim 14, additionally comprising a data collaboration server configured for holding and synchronizing cobrowsing between said clients.

20. The system of claim 14, wherein said step of modifying includes, accessing at least one predetermined rule from a storage media.

21. The system of claim 20, wherein said at least one predetermined rule is selected from the group comprising at least one of: a command, a source or a destination.
